(19) United States
(12) Patent Application Publication
(10) Pub. No.: US 2026/0309988 A1
(43) Pub. Date: Oct. 8, 2026

(54) HYBRID OPTICAL ELEMENTS INTEGRATING HOMOGENEOUS AND HETEROGENOUS COMPOSITION

(71) Applicant: Vadient Optics, LLC, Tualatin, OR (US)

(72) Inventors: George Melville Williams, Jr., Vashon, WA (US); John Paul Harmon, Albany, OR (US)

(21) Appl. No.: 19/479,027

(22) PCT Filed: Apr. 29, 2024
(86) PCT No.: PCT/US2024/026815

§ 371 Date: Oct. 27, 2025

Related U.S. Application Data
(60) Provisional application No. 63/498,652, filed on Apr. 27, 2023.

(51) Int. Cl. G02B 27/01; G02B 3/00; G02B 13/00; G02B 27/00

(52) U.S. Cl. CPC G02B 27/0172; G02B 3/0087; G02B 13/006; G02B 27/0062; G02B 2027/011; G02B 2027/0178

(57) ABSTRACT

Disclosed is a hybrid optical device comprising a first component including a homogeneous region of dielectric property, and a second component including a heterogeneous region of dielectric property. As an example, a homogeneous-index optical element is integrated with a gradient indexed property device in which optical functions of the device are complementary. In at least some examples, a nanocomposite gradient index optical element is fabricated directly onto an optical element to provide the degrees of freedom appropriate to provide complementary optical power, or to reduce or correct for aberrations of a homogeneous region of dielectric property of the optical element.

### CROSS REFERENCE TO RELATED APPLICATIONS

U.S. This application claims priority to and the benefit of U.S. Provisional Application Ser. No. 63/498,652, filed Apr. 27, 2023, the entirety of which is hereby incorporated herein by reference for all purposes.

### INCORPORATION BY REFERENCE

U.S. patent application Ser. No. 14/888,665, filed 2 Nov. 2015 and entitled GRADIENT REFRACTIVE INDEX OPTICS WITH LOW DISPERSION USING NANOPARTICLES, and U.S. patent application Ser. No. 17/811,187, filed 7 Jul. 2022 and entitled LIMITING CHROMATIC DISPERSION IN GRADIENT REFRACTIVE-INDEX OPTICS are incorporated herein by reference for all purposes.

### TECHNICAL FIELD

The disclosure herein relates generally to the design and fabrication of optical systems, operational in the electro-magnetic (EM) spectrum including the optical and radio-frequency spectral ranges. More particularly the disclosure relates to using additive manufacturing of variable property materials to form gradient property devices that augment the properties of a lens or other optical device.

### SUMMARY

The present disclosure describes a hybrid device and methods for fabricating the hybrid device that comprises a homogeneous optical element upon which is fabricated or attached a gradient property optical device, which together provide complementary optical functionality. In an example, inkjet printing of a gradient index (GRIN) optic is performed directly on a homogeneous index glass or plastic optical element or optical assembly to reduce aberrations in the homogeneous structure. The gradient index profiles may be varied to augment the optical or dispersive power of the device, and to correct optical aberrations. The term homogeneous here is meant to imply non-gradient devices, and can include devices that are bonded together, or which implement waveguides. It is not limited to devices that are strictly-homogeneous. As applied to an optic, device, or portion of a device, the term ‘homogeneous’ means that the material does not support a gradient refractive index or other variable dielectric property feature, as does a GRIN lens. However, ‘homogeneous’ devices may be combined with adjoining portions that differ in the refractive index or other dielectric property.

### BRIEF DESCRIPTION OF THE DRAWINGS

FIG. 1 shows aspects of an example positive lens (converging lens) and an example negative lens (diverging lens).

FIG. 2 shows aspects of an example pancake-lens augmented reality (AR) headset.

FIG. 3 shows aspects of an example progressive positive lens.

FIG. 4 shows aspects of an example AR head-up display.

FIG. 5 shows aspects of an example achromatic lens with conjoined converging and a diverging lenses, which cause lights at two wavelengths to converge at the same location.

FIG. 6 shows aspects of an example cemented triplet with three glass types.

FIG. 7 shows aspects of an example surface-figured GRIN lens.

FIG. 8 shows aspects of example gradient-index inks plotted in three-dimensional parameter space (index, dispersion, partial dispersion).

FIG. 9 shows aspects of an example solution space of four particular optical inks.

FIG. 10 shows aspects of example gradients of a heterogeneous map of a solution for a heterogenous region that is proportional/complementary to the homogeneous element.

FIGS. 11 and 12 show aspects of an example positive two-surface lens, wherein the degrees of freedom are the material refractive index and the two surfaces (which for spherical lenses have radii of curvature R1 and R2).

FIGS. 13 and 14 show examples analogous to those of FIGS. 11 and 12, where coma aberrations are shown, and the 3D GRIN profile (with both axial and radial gradient terms) functions to reduce coma.

FIGS. 15 and 16 show examples of a positive, two-surfaced lens with chromatic aberrations that cannot be reduced without additional lenses.

FIG. 17 shows aspects of an example GRIN lens printed on a homogeneous-index lens.

FIG. 18 shows aspects of another example GRIN lens printed on a homogeneous-index lens.

FIGS. 19 and 20 shows aspects of example GRIN lenses printed on homogeneous-index, planar optics.

FIG. 21 shows aspects of a GRIN printed on a homogeneous optic with a waveguide and a grating.

FIG. 22 shows aspects of an example fixture for holding a homogeneous lens during the printing of a GRIN layer thereon.

### DETAILED DESCRIPTION

As briefly introduced above, one aspect of this disclosure relates to a hybrid optical component that refracts electromagnetic (EM) radiation. As described herein, EM radiation can comprise visible, infrared, ultraviolet, or radio-frequency radiation. The hybrid optical component comprises a first component including a homogeneous region of dielectric property, and a second component including a heterogeneous region of dielectric property. A varying composition of the heterogeneous region imparts a gradient in the dielectric property within the heterogeneous region. In contrast to the heterogenous region described in further detail herein, the dielectric property of the homogenous region is fixed.

As an example, the disclosed heterogeneous region of the hybrid optical device can include a gradient in the dielectric property that attains or exceeds a threshold variation (e.g., 5% or other suitable value). In at least some implementations, the gradient in the dielectric property of the heterogeneous region comprises a dispersion gradient, and the heterogeneous region comprises an iso-indicial region of an iso-indicial value associated with a range of dispersion values, which vary by more than 5%. In at least some implementations, the gradient comprises a refractive-index gradient, and the heterogeneous region comprises an iso-dispersion region of an iso-dispersion value associated with a range of refractive-index values, which vary by more than 5%. In at least some implementations, the gradient comprises a partial-dispersion gradient, and the heterogeneous region comprises an iso-indicial region of an iso-indicial value associated with a range of partial-dispersion values, which vary by more than 5%. In at least some implementations, the heterogeneous region comprises an iso-dispersion region of a dispersion value associated with a range of partial-dispersion values, which vary by more than 5% within the iso-dispersion region. Additionally or alternatively, in at least some implementations, the heterogeneous region exhibits a rate of change of refractive index δn/δ(x,y,z) that is greater than or less than that a rate of change of either dispersion δV/δ(x,y,z) or partial dispersion δP/δ(x,y,z), in at least one orientation.

In at least some implementations, the heterogeneous region is additively manufactured via inkjet, multi-jet fusion, drop on demand printing, powder-bed, stereolithographic, or fused deposition modeling (FDM). In at least some implementations, the heterogeneous region is formed of a plurality of component materials (e.g., three or more component materials), and the dielectric property is a function of wavelength of the EM radiation.

Classical optical imaging systems consist of a series of refracting (or reflecting) surfaces interfacing among homogeneous isotropic materials of dielectric property that generally have a common axis of rotational symmetry. The surfaces are used to bend light rays originating from an object following the laws of geometrical optics to form an image. Optical lenses can be used throughout the electromagnetic (EM) spectrum including the x-ray, ultraviolet, infrared, radio-frequency, and millimeter wave ranges.

The present disclosure describes a hybrid device and methods for fabricating a hybrid device that comprises a homogeneous region of dielectric property (e.g., a homogeneous optical element) upon which is fabricated or attached a heterogeneous region (e.g., a gradient property optical device), which together provide complementary optical functionality. In an example, inkjet printing of a gradient index (GRIN) optic, as an example of a heterogeneous region, is performed directly on a homogeneous index glass or plastic optical element or optical assembly to reduce aberrations in the homogeneous structure. The gradient index profiles can be varied to augment the optical or dispersive power of the device, and to correct optical aberrations.

The term ‘homogeneous’ herein is meant to imply non-gradient devices, and can include devices that are bonded together, or which implement waveguides. It is not limited to devices that are strictly-homogeneous. As applied to an optic, device, or portion of a device, the term ‘homogeneous’ means that the material does not support a gradient refractive index or other spatially variable dielectric property, as does a GRIN lens. However, ‘homogeneous’ devices may be integrated with adjoining portions that differ in the refractive index or other dielectric property.

The term ‘lens’ is the common name given to a component of glass or transparent plastic material, usually circular in diameter, which has two primary surfaces that are ground and polished in a specific manner designed to produce either a convergence or divergence of light passing through the material. Optically transparent materials (“glass”) have an index of refractionn>1, and light hitting a transparent material is reflected and refracted.

Optical design is a scientific and engineering discipline where the goal is often to construct an optimal optical system that enables an optical task, such as imaging, while minimizing the errors, or optical aberrations, introduced by the optical elements by utilizing the effective degrees of freedom, such as the number and position of elements, including the aperture stop, as well as their physical shapes and materials. In another sense, optical design may have the goal of mapping an entire space of solutions that can be later ranked according to some design criteria or application.

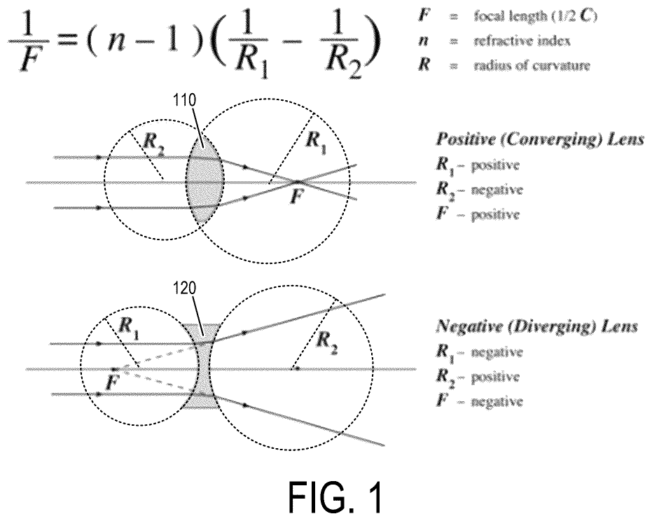

Lenses can be either positive (converging) or negative (diverging) depending upon whether the lens causes light rays passing through the lens to converge into a single focal point or diverge outward from the optical axis and into space. Positive lenses, such as positive lens 110 of FIG. 1, converge incident light rays that are parallel to the optical axis and focus the light rays at the focal plane to form a real image. Positive lenses have one or two convex surfaces and are thicker in the center than at the edges. A common characteristic of positive lenses is that they magnify objects when they are placed between the object and the human eye. In contrast, negative lenses, such as negative lens 120 of FIG. 1, diverge parallel incident light rays and form a virtual image by extending traces of the light rays passing through the lens to a focal point behind the lens. Negative lenses have at least one concave surface and are thinner in the center than at the edges. When a negative lens is placed between an object and the eye, it does not form a real image, but reduces (or demagnifies) the apparent size of the object by forming a virtual image.

Fundamental considerations show that perfect imaging is possible in principle, but only with unit magnification. According to the Gaussian optics approximation of small angles, the law of refraction takes a simple (linear) form. In this paraxial approximation, all the rays diverging from a point object and propagating through the system converge to a point named the Gaussian image point. However, beyond this approximation, rays are traced according to the exact geometrical optics laws and they generally do not converge to a point, resulting in aberrations.

In optics, aberration is a property of optical systems, such as lenses, that causes light to be spread out over some region of space rather than focused to a point. With an ideal lens, light from any given point on an object would pass through the lens and come together at a single point in the image plane (or, more generally, the image surface). Real lenses do not focus light exactly to a single point, however, even when they are perfectly made. With a few exceptions, even if the lenses were perfect in terms of the spherical shape of the surfaces and centering on the optical axis, the image is affected by basic defects known as aberrations. Aberrations are intrinsic to the mechanism of image formation by refraction or reflection and become significant as the aperture and the field depart more and more from infinitesimal values.

Aberrations fall into two classes: monochromatic and chromatic. Monochromatic aberrations are caused by the geometry of the lens or mirror and occur both when light is reflected and when it is refracted. They appear even when using monochromatic light, hence the name.

There are five Seidel aberrations. Three of them-spherical aberration, coma, and astigmatism—cause basic deterioration of the image quality, making it blurred. The remaining two—Petzval field curvature and distortion—alter the image geometry. The term, “(five) Seidel aberrations,” is the generic name of the third-order aberrations (third order with respect to the product of α (angle between the optical beam and optical axis) and r (distance of the optical beam from the optical axis)), which occurs for a monochromatic but non-paraxial electron beam. The five aberrations are
(1) spherical aberration (proportional to α³),
(2) (off-axial) coma aberration (proportional to rα²),
(3) off-axial astigmatism (proportional to r²α),
(4) curvature of image field (proportional to r²α), and
(5) distortion (proportional to r³).

Spherical aberrations cause soft-focused images that lack fine contrast. They occur when light passing through the edges of a lens focuses closer to the lens than light passing through its center. Coma describes the reduced ability of a lens to render a sharp point image that originates away from the lens axis. Curvature of field occurs when a lens cannot focus a flat subject normal to its optical axis onto a flat image plane. Astigmatism causes a subject point originating away from the lens axis to render as a highly stretched oval at one focus distance, as a highly stretched oval perpendicular to the first at another focus distance, and as a blurry disc in between. There are two types, tangential and sagittal astigmatism. In tangential astigmatism, the elongation of the subject points occurs along an imaginary line radiating from the optical axis, whereas in sagittal astigmatism, the elongation is normal to this, appearing to follow imaginary rings circling the optical axis. Linear distortions are deviations from an ideal rectilinear projection.

This wavefront coefficient arises from the mathematical summation that gives the actual difference between the perfect and aberrated wavefronts:

$$W = {\sum }_{l + {k}_{M} = 0}^{∞} {W}_{k , l , m} {H}^{k} {ρ}^{l} {cos}^{m} ( cos ( θ ) )$$

Wₖₗₘ is the wavefront coefficient, H is the normalized image height, ρ is the location in the pupil, and θ is the angle between the two, which arrives due to the dot product of the two vectors. Once the wavefront coefficient is known, the order number can be determined by adding l and k. However, this will always create an even number. Since optical aberrations are often referred to as first, third, fifth-order, etc., if k+1=2, it is a first-order aberration, if k+1=4 it is a third order, etc. Generally, the first and third-order aberrations are most often addressed in system analysis.

Seidel aberrations, are given by

$$w ( ρ , θ ) = {s ( ρ d )}^{4} + c {α ( ρ d )}^{3} cos θ + a {{α}^{2} ( ρ d )}^{2} {cos}^{2} θ + u {{α}^{2} ( ρ d )}^{2} + g {α}^{3} ( ρ d ) cos θ$$

where s, c, a, u and g are aberration coefficients for spherical aberration, coma, astigmatism, field curvature and distortion, respectively, α is the field angle, ρd is the height in the pupil, with d being the nominal pupil radius and ρ the relative (0 to 1) height in the pupil, and θ the pupil angle (absent in radially symmetrical aberrations, like spherical), determining pupil coordinate at which the image point originates. Since the sum of the powers in a and d terms is 4, they are also called 4th-order wavefront aberrations.

For the corresponding transverse ray aberration form, the sum of these two powers is 3—for instance, it is (ρd) ¾f², 3α(ρd) 2/4f, and ρdα² for spherical aberration (diameter, paraxial focus, half as much at the best focus), tangential coma and astigmatism (diameter, best focus), respectively—so these are called 3rd-order transverse ray aberrations (f is the focal length, while the term in ρ shows how the aberration varies with the ray height in the pupil). The next higher aberration order are 6th-order wavefront and 5th-order ray aberrations (as mentioned, they are also called secondary, or Schwarzschild aberrations).

The first three primary aberrations-spherical, coma and astigmatism-result from deviations in the wavefront form from spherical. Consequently, their effect is deterioration in the quality of point-image. The last two-field curvature and distortion—are image-space aberrations, resulting from deviations in wavefront radius or orientation (tilt), respectively.

The only primary aberration independent of the point height in image plane is spherical aberration—it remains constant across the entire image field. The two aberrations that are independent of pupil angle θ—spherical and field curvature—are symmetrical about the pupil center. In other words, their property is identical in any given direction from the point image center (spherical aberration), or from the image field center (field curvature).

In terms of Seidel aberration calculation, the aberration function takes the form:

$$w ( ρ , θ ) = ( {S}^{′} / 8 ) {ρ}^{4} + ( {C}^{′} / 2 ) h {ρ}^{3} cos θ + ( {A}^{′} / 2 ) {h}^{2} {ρ}^{2} {cos}^{2} θ + ( {U}^{′} / 4 ) ( {A}^{′} + P ) {h}^{2} {ρ}^{2} + ( {G}^{′} / 2 ) {h}^{3} p cos θ$$

with S′, C′, A′, U′ and G′ being the Seidel sums for spherical aberration, coma, astigmatism, field curvature and distortion (usually denoted by S_{I}, S_{II}, S_{III}, S_{III}+S_{IV} and S_{V}), P being the Petzval sum (denoted by S_{IV}), and h the point image height in the Gaussian image space normalized to the maximum object height hₘₐₓ=1.

The primary aberration targets of a thin lenses are normally the following three: spherical aberration, central coma and longitudinal chromatic aberration. Central coma is defined as the coma value for the case of the stop located at the lens. The other primary aberrations: astigmatism, field curvature, distortion, and lateral chromatic aberration can be expressed as combinations of the three primary aberrations by using the well—known stopshift formulae of aberration theory

The number of degrees of freedom in optics is most often understood to be the number of independent parameters needed to represent an optical signal or system. Traditional optical design aims at minimizing such aberrations via multiple surface and/or multiple material systems that meet a set of performance requirements and constraints. In effect, current approaches to isomorphic imaging take advantage of various freedoms to improve lens performance.

There are certainly limits as to how well a singlet lens can perform. A spherical singlet, with a homogeneous index, n, has only two surfaces (R₁ and R₂, where R is the radius and the index 1 is the first surface and the 2 the second surface) to meet the targets of optical power, K, and one monochromatic aberration.

A doublet is a type of lens made up of two simple lenses paired together. Such an arrangement allows more optical surfaces, thicknesses, and formulations, especially as the space between lenses may be considered an “element”. With additional degrees of freedom, optical designers have more latitude to correct more optical aberrations more thoroughly. For example, cemented doublets with three surfaces can meet the focal length and two of the three aberrations. The larger effects are the three radius of curvature, which give three degrees of freedom to correct the focal length, the spherical aberration, chromatic aberration.

Simply separating the lens into two lenses provides two degrees of freedom. Namely, the lens bending of the entire system, and the lens bending of the negative lens alone. This added degree of freedom allows one to control the coma more freely than before. However, as soon as there are two lenses that are not cemented, the issues of lateral displacement of the lenses and separation of the lenses arise, so the tolerance is much more difficult to overcome. So there are some consequences.

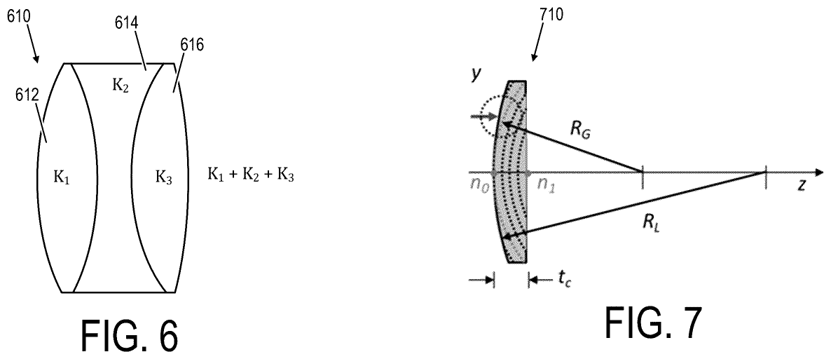

A triplet lens (e.g., see FIG. 6) is a compound lens consisting of three single lenses. The triplet design is the simplest to give the desired number of degrees of freedom to allow the lens designer to overcome all Seidel aberrations. The three lenses may be cemented together. Spherical aberration, coma, and astigmatism, can all be corrected due to the degrees of freedom with the 3 lens bending. Cemented triplets which have four surfaces as constructional degrees of freedom can meet the targets K (optical power), Spherical Aberrations, Central Coma, and longitudinal chromatic aberrations. Alternatively, the triplet may be designed with three spaced glasses, as in the Cooke triplet. This has the advantage of higher optical throughput due to fewer air-glass interfaces, but the latter provides greater flexibility in aberration control, as the internal surfaces are not confined to have the same radii of curvature.

The triplets in FIG. 6 uses three different glasses and has five surfaces as constructional degrees of freedom which may be used to meet the specified amounts of power (focal length), spherical aberrations, central coma, longitudinal chromatic aberrations, and secondary color aberrations.

Odd-order surface contains odd-order powers of radial coordinate unlike conventional aspherical surfaces and thus provides new degrees of freedom in optical design. Since odd-order surfaces consist of powers of absolute value of radial coordinates, they are rotationally invariant.

Aspheric optical elements are components for modern optical systems, by adding more degree of freedom for the optical system design, they are capable of correcting aberrations, improving image quality, and minimizing the structure of certain systems. An aspherical lens is a lens whose lens surface is not spherical. By using lenses with aspherical surfaces, which offer a high degree of freedom in design. An aspheric surface can be defined by either a conic or a fourth-order aspheric coefficient. In some situations, conic surfaces must be adopted to satisfy the required aperture diameters. Due to their optical shapes/surfaces, which have few or no symmetry, freeform optics have many degrees of freedom.

Aspheric surfaces are usually superior to spherical ones in correcting optical aberrations. A common form of aspheric surface is defined by the following sag equation:

$$z = \frac{c {h}^{2}}{1 + \sqrt{1 - ( 1 + k ) {c}^{2} {h}^{2}}} + α {h}^{4} + {α}_{6} {h}^{6} + {α}_{8} {h}^{8}$$

where h is the radial coordinate, c is the base curvature at the vertex, κ is the conic coefficient, a is the fourth-order coefficient, and an are the higher-order (larger than fourth-order) aspheric terms. Although there are many constructional parameters, only c, κ, and α have contributions to the primary aberrations.

Freeform optics are refractive and reflective surfaces that differ significantly from spherical and aspheric geometries. Based on their special surface shape, freeform optics can provide functions that cannot be achieved with classic optics. However, Unrestricted use of freeform terms on multiple surfaces within a system can result in aberration correction degeneracy, where like-terms on separate surfaces balance one another out, resulting in a potential large increase in freeform departure for each surface with little performance gain.

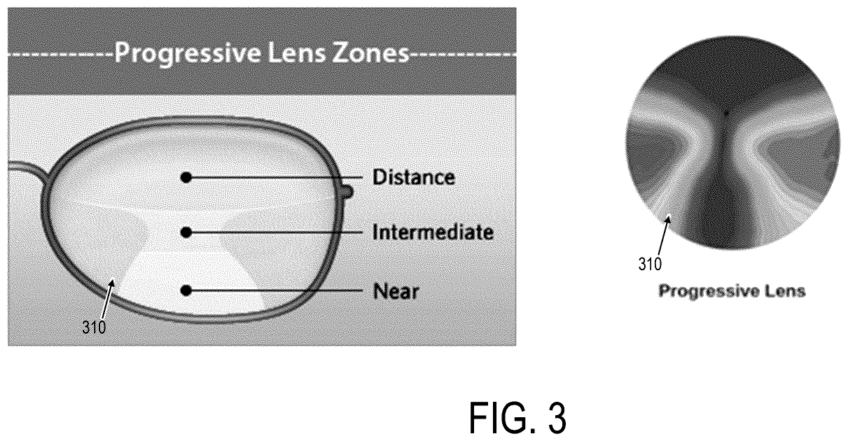

Freeform lenses are commonly used, for example, for progressive lenses used in vision accommodation. The simplest eyeglasses to correct presbyopia are monofocal lenses that can only be used for near vision. A more complex type of eyeglasses are bifocal lenses, allowing clear vision at two different distances: far vision and near vision. Finally, the third type of eyeglasses are progressive lenses (also called progressive addition lenses) that have a complex design, including an upper region for far vision (far region), a corridor for middle vision, and a lower region for near vision (near region). The different parts of a progressive lens surface are shown in FIG. 3, for example, with respect to a positive progressive lens 310.

A double-sided progressive lens that can substantially improve near vision and intermediate vision as well as viewing width. For example, a simple spherical or cylindrical function can be implemented on one side and on the other, customized progressive functions can be implemented. Alternatively, the lens can have a progressive grind on one of its sides, and an additional optical function, such as a conical torus, on the other side, which may provide additional power or correct for aberrations of portions of the near or far vision.

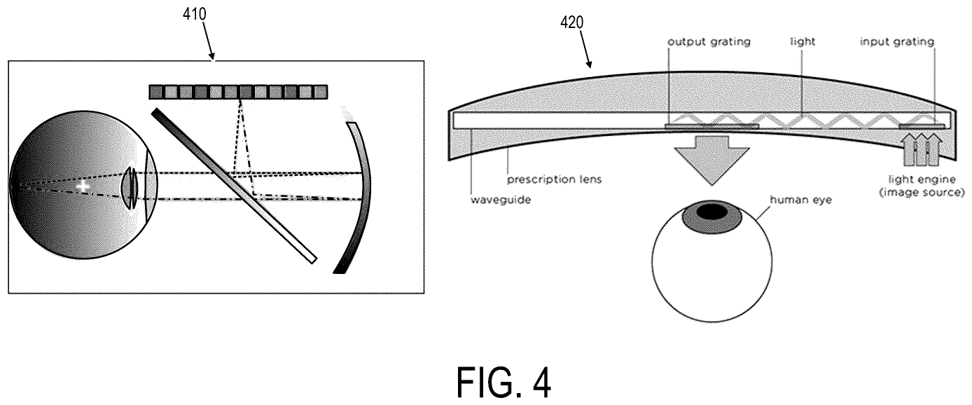

Augmented and mixed reality (AR/MR) devices share a key characteristic that sets them apart from virtual reality (VR) devices: AR/MR devices are transparent. The hallmark of VR devices is how they completely encompass the wearer's field of view inside a headset to create an immersive virtual environment. By contrast, AR/MR smartglasses and other headsets project images onto a clear display surface that enables the wearer to see through to the real world. Both waveguides and visors (see e.g., FIG. 4) are passive optical elements that convey or form the image that is generated by an external electronic source (usually either a projector, a micro display, or an LCoS display). The principal technology that has enabled augmented visualization in AR/MR are waveguides: a thin piece of clear glass or plastic with specific light transmitting properties. Passive optics may be used on both sides of waveguides to provide uniform gain on the display and the real world image, as experienced by the user. Passive optics are also needed to accommodate the individual prescription of users.

### Chromatic Aberrations

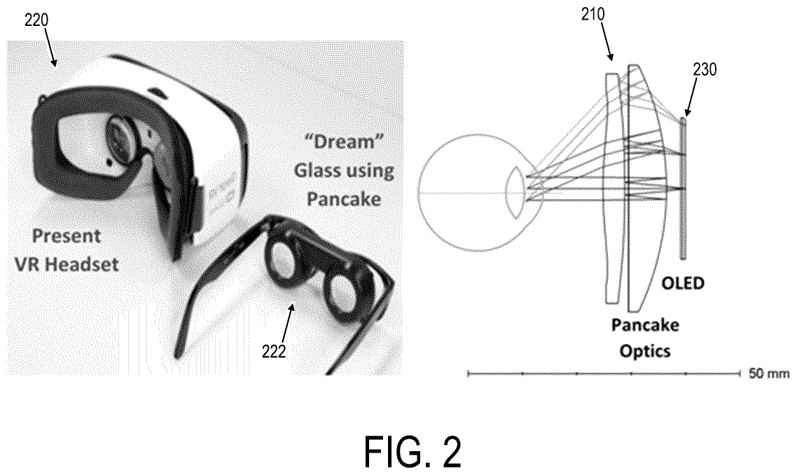

The refractive index of any transparent material is a function of the wavelength. Therefore, a lens made in one single material shows different positions of focus at each wavelength. The difference in position of these focal points is known as the longitudinal primary chromatic aberration. To correct this aberration, achromatic lenses are usually manufactured using two lenses of different material having different Abbe numbers combined to form an achromatic doublet (FIG. 2). However, unless the material pair is carefully chosen, secondary color will remain. Triplets can then be employed to correct some higher orders of chromatic aberrations, such as secondary color, at the expense of increased system size, weight, and cost.

Chromatic aberrations are caused by dispersion, the variation of a lens's refractive index with wavelength. Because of dispersion, different wavelengths of light come to focus at different points. Chromatic aberration does not appear when monochromatic light is used.

Light dispersion is cause by the dependence of refractive indices on wavelength. The dispersive power of a material depends on the variation magnitude of its refractive index in the visible range. Consider a white ray entering from air into a transparent object of refractive index n(λ) with incident angle θᵢ. The refractive angle θₜ(λ) depends on wavelength in terms of Snell's law:

$$sin [ {θ}_{i} , ( λ ) ] = [ \frac{sin {θ}_{i}}{n ( λ )} ] \#$$

Let δn be the variation of n(λ) in the visible range. Since δn is much smaller than n(λ), the corresponding spread angle can be derived.

$$Δ θ = \frac{δ n}{n ( λ )} tan [ {θ}_{t} ( {θ}_{i} ) ]$$

To estimate the extent of Δθ, it can be assumed that n(λ) is 1.4 (this value is close to or below the refractive indices of most materials). Then the maximum of θₜ(Δ) for all incident angles is about 45 degree and tan [θₜ(λ)] is close to or below 1. This means that the extent of the spread angle Δθ is determined by δn/n.

The common way to describe the dispersive power of a material is through the V-number or Abbe number,

$$V = \frac{{n}_{D} - 1}{{n}_{F} - {n}_{C}}$$

where n_{C}, n_{D}, and n_{F} are the refractive indices at the C, D and F Fraunhofer lines, respectively. A small V-number means a large dispersive power.

The standard solution to correct axial color aberrations is to replace a homogeneous singlet with a doublet composed of two different materials with different Abbe numbers. Triplets can then be employed to correct some higher orders of chromatic aberrations, such as secondary color

Generally, in order to minimize the optical power for each individual element when correcting color, the ratio of the two Abbe numbers should be as large as possible. In doing so, the differing dispersions of the two materials are able to balance one another in order to bring two wavelengths to the same focus. For ordinary optical glasses, the relationship between the partial dispersion ratios and the Abbe number is roughly linear. Secondary color chromatic aberrations in lens doublets or triplets may be controlled using optical glasses with anomalous relative partial dispersion, P, which departs from the normal straight-line relationship with the Abbe number on a P=f(V) diagram.

If we consider two wavelengths of red, 633 nm, and blue, 480 nm, it is observed that the focal point of the blue is closer to the lens than that of the red light. This can be better explained through the following equation.

$$\frac{1}{f} = ( {n}_{i} - 1 ) ( \frac{1}{{R}_{1}} - \frac{1}{{R}_{2}} ) = ( {n}_{i} - 1 ) li$$

In this equation, the R1 and R2 are the front and back curvatures of the lens i with refractive index ni.

This chromatic aberration can be minimized by using a system of two lenses with different refractive indices. Usually, such a system consists of a converging and diverging lens that are conjoined together permanently. This system of lenses is referred to as an achromatic lens or simply as an achromat. When these two lenses are in close contact with each other, equation (2) can be written as follows.

$$\frac{1}{f} = ( n 1 - 1 ) l 1 + ( n 2 - 1 ) l 2$$

In an achromatic lens, a focal point is desired at a red wavelength equal to that of a blue wavelength. Therefore, the focal points for red and blue wavelengths will be the same if represented in the equation.

$$( {n}_{1 r} - 1 ) {l}_{1} + ( {n}_{2 r} - 1 ) {l}_{2} = ( {n}_{1 b} - 1 ) {l}_{1} + ( {n}_{2 b} - 1 ) {l}_{2}$$

This means that the ratio of I1 over I2 will be

$$\frac{{l}_{1}}{{l}_{2}} = \frac{{n}_{2 b} - nrb}{{n}_{1 b} - {n}_{1 r}}$$

one may calculate the focal point of two lenses by employing equation (1) and solving for the refractive index at the green wavelength which is considered to be lying at the midpoint of blue and red wavelengths

$${n}_{g} = 1 / 2 ( {n}_{b} - {n}_{r} )$$

$$\frac{{f}_{2}}{{f}_{1}} = \frac{( {n}_{1 g} - 1 ) {l}_{1}}{( {n}_{2 g} - 1 ) {l}_{2}} = \frac{( {n}_{1 g} - 1 ) ( {n}_{1 b} - {n}_{2 r} )}{( {n}_{2 g} - 1 ) ( {n}_{1 b} - {n}_{1 r} )}$$

This can be represented in abbe values (v)

$$v = ( {n}_{g} - 1 ) / ( {n}_{b} - {n}_{r} ) = δ g / Δδ$$

$$1 / ( {f}_{1} {v}_{1} ) - 1 / ( {f}_{2} {V}_{2} )$$

This analysis leads to form the condition needed to make an achromatic lens when the first lens amongst the two conjoined lenses is symmetrical. The second radius of the first lens will be equal to the first radii of the second lens (R12=R21) where the system of the lens will yield the radius of the first lens as its first radius and the second radius of the second lens as its second radius (R1=R11 and R2=R22).

$${R}_{1} = \frac{2 ( {n}_{1 g} - 1 ) ( {v}_{1} - {v}_{2} )}{{v}_{1}}$$

$${R}_{2} = \frac{2 ( {v}_{1} - {v}_{12} ) f}{\frac{2 {v}_{2}}{{n}_{2 g} - 1} - \frac{{v}_{1}}{{n}_{1 g} - 1}}$$

In view of the above, FIG. 1 shows aspects of an example positive lens 110 (converging lens) and an example negative lens 120 (diverging lens). Within FIG. 1, a relationship between focal length, refractive index, and radius of curvature is provided for positive lens 110 and negative lens 120. The hybrid optical device disclosed herein that comprises a first component including a homogeneous region of dielectric property, and a second component including a heterogeneous region of dielectric property can incorporate or take the form of a positive lens (e.g., 110 of FIG. 1) or a negative lens (e.g., 120 of FIG. 1).

FIG. 2 shows aspects of an example pancake-lens 210 that can be incorporated into virtual reality and augmented reality headsets shown at 220 and 222, respectively. Pancake-lens 210 can be used in conjunction with a graphical display 230 (e.g., an OLED display). The hybrid optical device disclosed herein that comprises a first component including a homogeneous region of dielectric property, and a second component including a heterogeneous region of dielectric property can incorporate or take the form of a pancake-lens (e.g., 210 of FIG. 2) that forms part of a virtual reality headset (e.g., 220 of FIG. 2) or an augmented reality headset (e.g., 222 of FIG. 2), as an example.

FIG. 3 shows aspects of an example progressive positive lens 310. The hybrid optical device disclosed herein that comprises a first component including a homogeneous region of dielectric property, and a second component including a heterogeneous region of dielectric property can incorporate or take the form of a progressive positive lens, as an example.

FIG. 4 shows aspects of an example AR head-up display. FIG. 4 shows passive optics 410 in front of a human eye (left) and a waveguide display, with optical power on both sides of an embedded a waveguide at 420. In this design, the near-eye side of the optic includes a prescription lens. The hybrid optical device disclosed herein that comprises a first component including a homogeneous region of dielectric property, and a second component including a heterogeneous region of dielectric property can incorporate or take the form of passive optics 410, including a prescription lens, as an example.

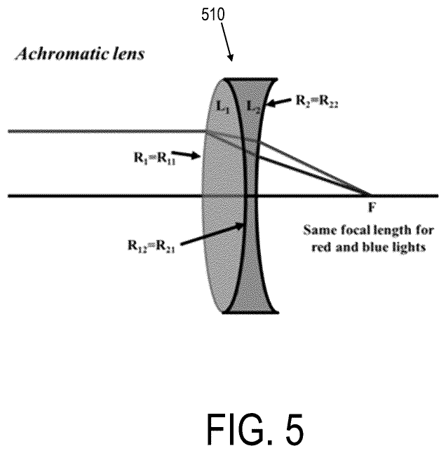

FIG. 5 shows aspects of an example achromatic lens 510 with conjoined converging and a diverging lens or lens components, which cause light at two wavelengths to converge at the same location. Achromatic lenses are traditionally manufactured using two lenses of different materials, having different Abbe numbers, and combined to form an achromatic doublet. Each lens or lens component of such achromatic lenses are traditionally formed by a respective homogenous region of dielectric property. The hybrid optical device disclosed herein that comprises a first component including a homogeneous region of dielectric property, and a second component including a heterogeneous region of dielectric property can incorporate or take the form of an achromatic lens, as an example.

FIG. 6 shows aspects of an example cemented triplet 610 with three glass types 612, 614, and 616. For three chosen glass types, there may be at most five thin-lens solutions, which meet the targets of power and optical aberrations. The degrees of freedom offered by the hybrid optical device disclosed herein can be used to correct for geometric aberrations and chromatic aberrations, by choice of the index and dispersion characteristics of the materials that form the heterogenous region.

FIG. 7 shows aspects of an example surface-figured GRIN lens 710 that can be used for a heterogeneous region of dielectric property of the disclosed optical device. The lens is defined by a center thickness t_{c}, surface radius of curvature RL, and a gradient index radius of curvature RG, both radii defined relative to the vertex of the lens on the left hand side (z=0). RG and RL are positive as shown.

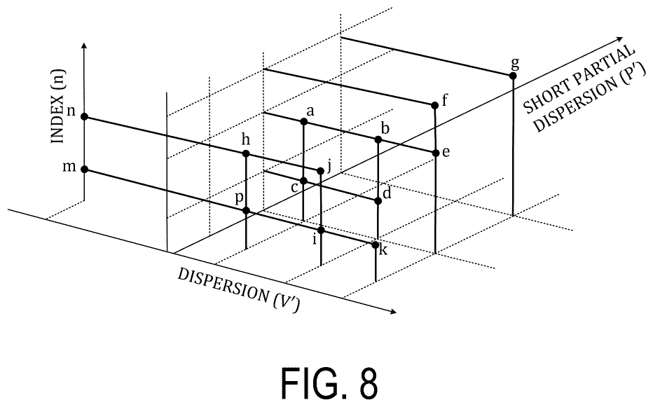

FIG. 8 shows aspects of example gradient-index inks (lettered a, b, c, d, e, f, g, h, i, j, k), plotted in three-dimensional parameter space (index, dispersion, partial dispersion). These gradient-index inks represent example materials that can be combined to form the a heterogeneous region of dielectric property of the disclosed hybrid optical device. The degrees of freedom afforded by nanocomposite materials and additive manufacturing allow for the precise control over the chromatic properties of gradient index (GRIN) optics. The ability to engineer nanocomposite optical materials using blends of three or more constituents (e.g., “inks”) makes it possible to independently specify the refractive index gradient and the dispersion of optical materials that form the heterogeneous region of dielectric property. The refractive index spectra of the primary nanocomposite feedstock are defined relative to one another using various concentrations of monomers and nanofillers, as an example. Inkjet deposition is then used to print-compose specific feedstock to form refractive index gradients with precise control over dispersion.

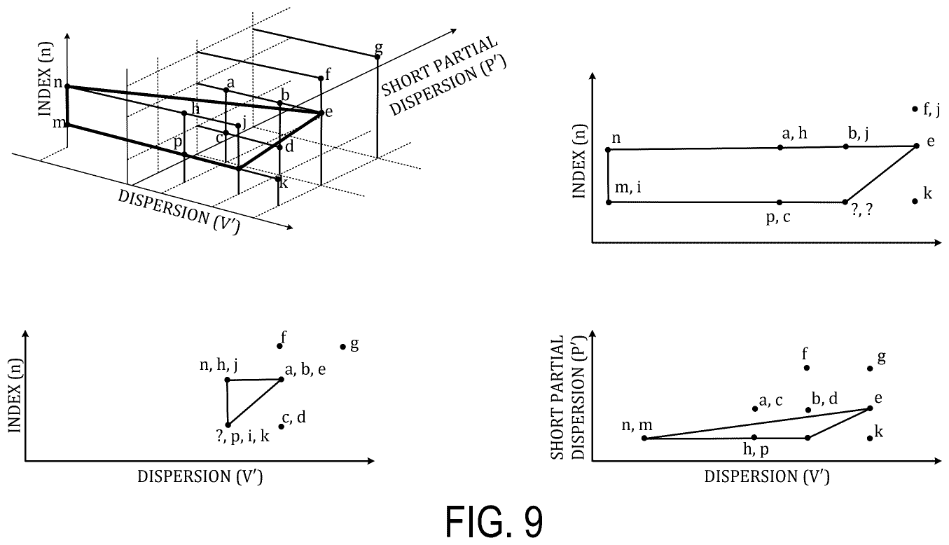

FIG. 9 shows aspects of an example solution space of four particular optical inks previously described with reference to FIG. 8. Gradients can be formed anywhere within the example polygons formed by the optical inks depicted in FIG. 9, such as by parton-composing the different materials of such inks.

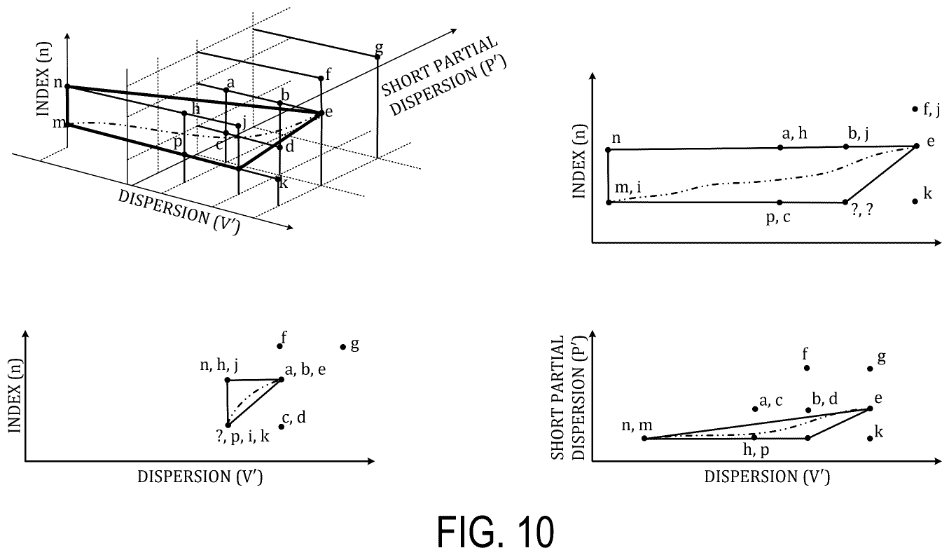

FIG. 10 shows aspects of example gradients (in broken lines) of a heterogeneous map of a solution for a heterogenous region that is proportional/complementary to the homogeneous element. The example gradients are formed within the polygons, as previously described with reference to FIG. 9.

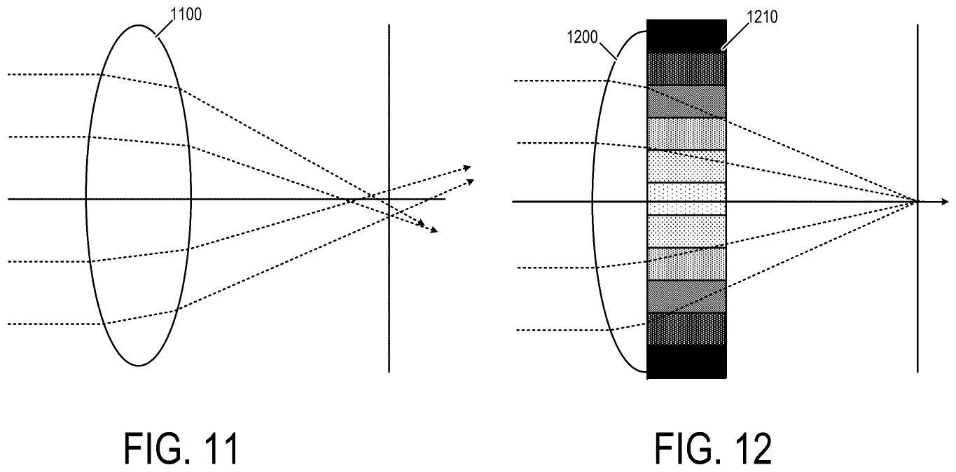

FIGS. 11 and 12 show aspects of an example positive two-surface lens, wherein the degrees of freedom are the material refractive index and the two surfaces (which for spherical lenses have radii of curvature R1 and R2). The two-surface lens 1100 of FIG. 11 is replaced by the configuration of FIG. 12 that comprises a homogeneous convex-plano lens 1200, with reduced degrees of freedom, augmented with a GRIN device 1210 (e.g., a GRIN lens), which can include 3D gradient profiles to reduce geometric aberrations and dispersion correcting materials to reduce chromatic aberrations. As an example, a GRIN lens can be printed directly onto the homogeneous lens 1200.

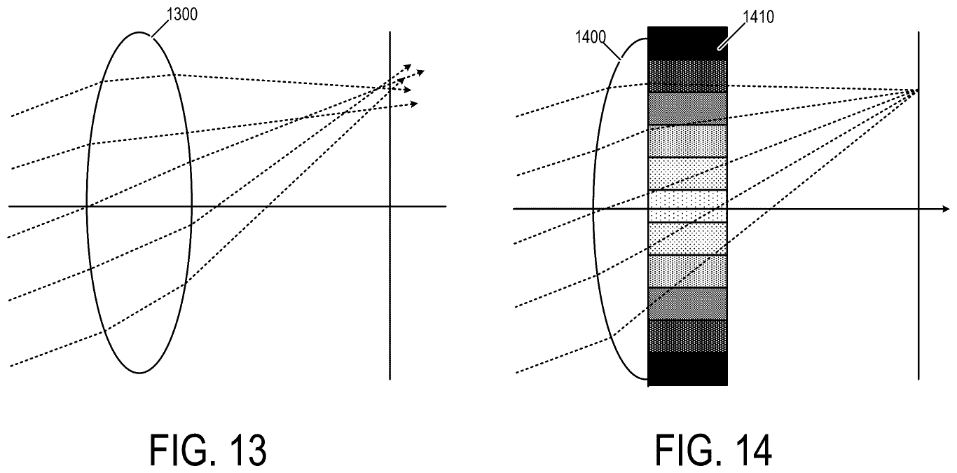

FIGS. 13 and 14 show examples analogous to those of FIGS. 11 and 12, where coma aberrations are shown in FIG. 13 for a lens 1300, and the 3D GRIN profile 1410 of FIG. 14, as an example of a heterogeneous region (with both axial and radial gradient terms), functions to reduce coma of homogeneous lens 1400 as shown in FIG. 14.

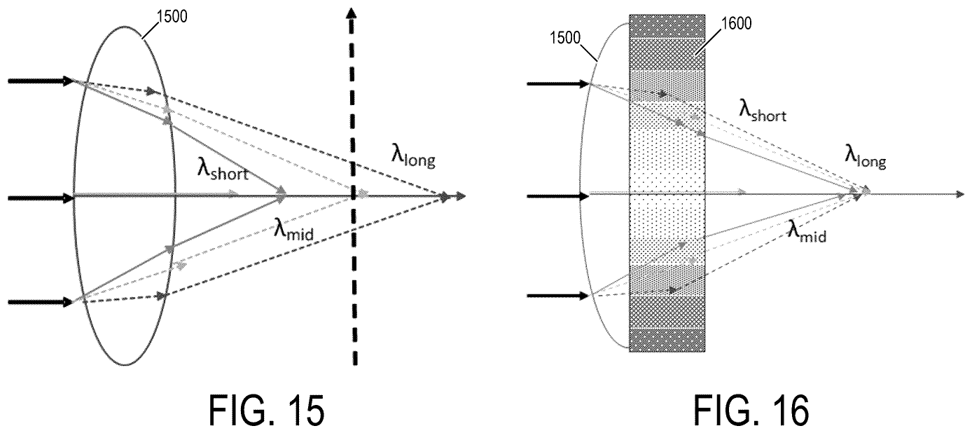

FIGS. 15 and 16 show examples of a positive, two-surfaced lens with chromatic aberrations that cannot be reduced without additional lenses. For example, in FIG. 15, a homogeneous lens 1500 exhibits chromatic aberrations. A multi-component GRIN 1600, as an example of a heterogeneous region, can be used to reduce chromatic aberrations of homogeneous lens 1500 as shown in FIG. 16. The GRIN profiles of the multi-component GRIN 1600 can be constructed to be proportional to the dispersion created at the lens surface of the homogeneous lens 1500, which means that the GRIN profiles are proportional to the sag of the homogeneous lens.

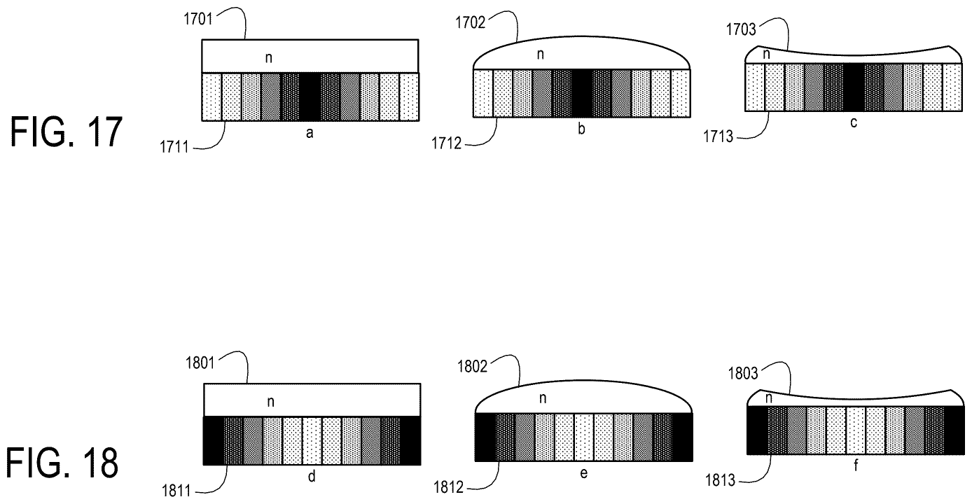

FIG. 17 shows aspects of an example GRIN lens printed on a flat portion of a homogeneous-index lens. GRIN functions are shown with a lower index in the middle, corresponding to the optical function of the homogeneous lens. In portion a of FIG. 17, GRIN lens 1711 and homogeneous-index lens 1701 are depicted in which lens 1701 has a planar upper surface on an opposite side from lens 1711. In portion b of FIG. 17, GRIN lens 1712 and homogeneous-index lens 1702 are depicted in which lens 1702 has a convex upper surface on an opposite side from lens 1712. In portion c of FIG. 17, GRIN lens 1713 and homogeneous-index lens 1703 are depicted in which lens 1703 has a concave upper surface on an opposite side from lens 1713.

FIG. 18 shows aspects of another example GRIN lens printed on a flat portion of a homogeneous-index lens. GRIN functions are shown with a lower index in the middle, corresponding to the optical function of the homogeneous lens. In portion d of FIG. 18, GRIN lens 1811 and homogeneous-index lens 1801 are depicted in which lens 1801 has a planar upper surface on an opposite side from lens 1811. In portion e of FIG. 18, GRIN lens 1812 and homogeneous-index lens 1802 are depicted in which lens 1802 has a convex upper surface on an opposite side from lens 1812. In portion f of FIG. 18, GRIN lens 1813 and homogeneous-index lens 1803 are depicted in which lens 1803 has a concave upper surface on an opposite side from lens 1813.

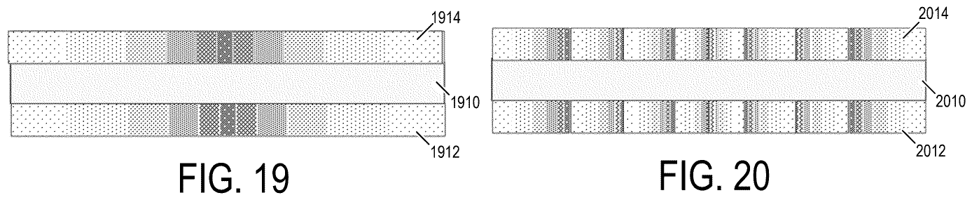

FIGS. 19 and 20 show aspects of example GRIN lenses (1912 and 1914 in FIG. 19, and 2012 and 2014 in FIG. 20) printed on homogeneous-index, planar optics (1910 in FIG. 19, and 2010 in FIG. 20). The term homogeneous is broadly understood to mean not-GRIN. The homogeneous element may be an assembly of bonded optical components. FIG. 19 shows a GRIN printed on two sides at 1912 and 1914 of the homogeneous-index lens 1910. FIG. 20 shows a GRIN printed at 2012 and 2014 with a Fresnel GRIN profile on the two sides of the homogeneous-index lens 2010.

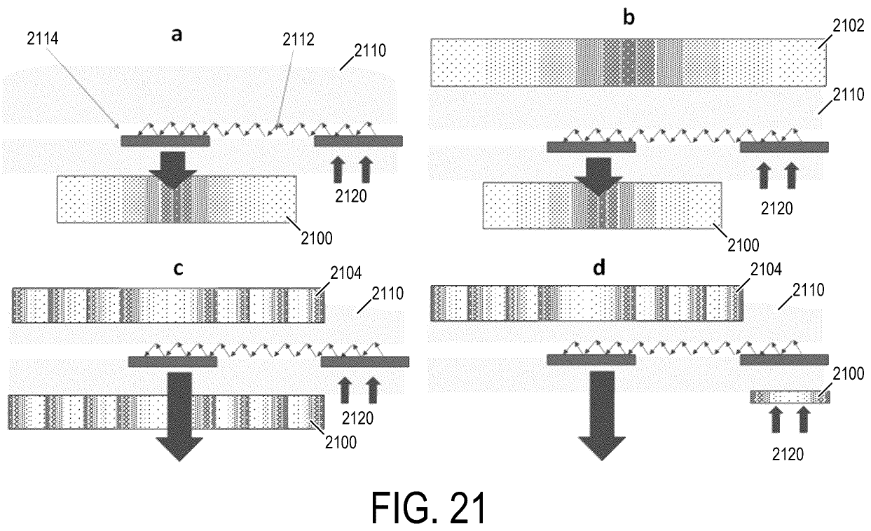

FIG. 21 shows aspects of a GRIN 2100 printed or otherwise provided on a homogeneous optic 2110 with a waveguide 2112 and a grating 2114. In the examples of FIG. 21, GRIN 2100 is provided as an example of a heterogeneous region, and homogeneous optic 2110 is provided as an example of a homogeneous region of a hybrid optical device. In portion a of FIG. 21, the path of input light 2120 passes through GRIN 2100 as it exits homogeneous optic 2110. In portion b of FIG. 21, another heterogenous region 2102 (e.g., a second instance of GRIN 2100 or other heterogenous region) is included on an opposing side of homogeneous optic 2110. In portion c of FIG. 21, another heterogenous region 2104 (e.g., a second instance of GRIN 2100 or other heterogenous region) is included on an opposing side of homogeneous optic 2110. In the example of portion c, heterogeneous regions 2100 and 2104 include a Fresnel GRIN profile. In portion d of FIG. 21, the path of input light 2120 passes through GRIN 2100 before entering homogeneous optic 2110, and another heterogenous region 2104 (e.g., a second instance of GRIN 2100 or other heterogenous region) is included on an opposing side of homogeneous optic 2110. In the example of portion d, heterogenous region 2104 includes a Fresnel GRIN profile, as an example.

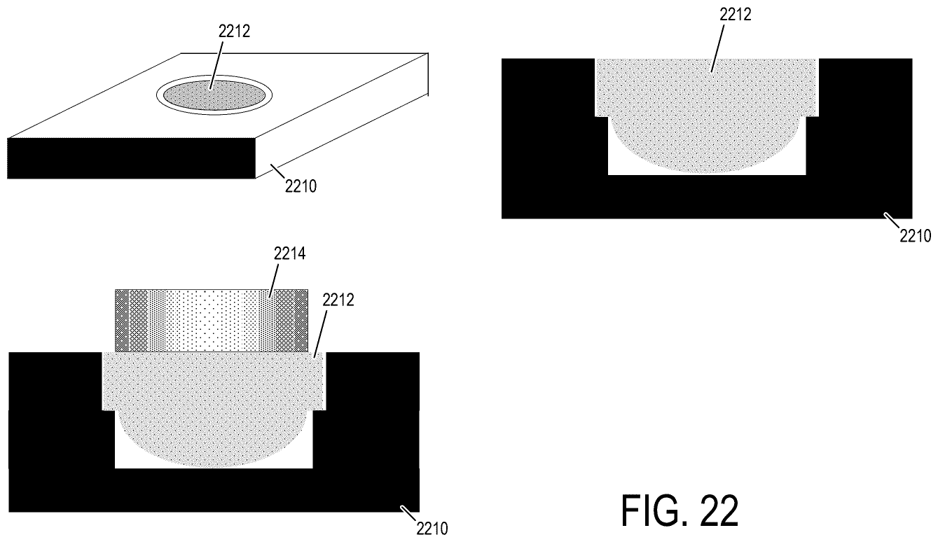

FIG. 22 shows aspects of an example fixture 2210 for holding a homogeneous lens 2212 during the printing of a GRIN layer 2214 thereon. In this example, GRIN layer 2214 is an example of a heterogenous region and homogeneous lens 2212 is an example of a homogeneous region of a hybrid optical device.

Within the context of the present disclosure, the term “index” is used to describe refractive index, but can be more generally applied to complex dielectric properties of a device, including permittivity and permeability. The refractive index, n, describes how matter affects light speed: through the electric permittivity, E, and the magnetic permeability, u. These properties describe how well a medium supports (permits the transmission of) electric and magnetic fields

$$n = \sqrt{\frac{ε}{{ε}_{0}} \frac{μ}{{μ}_{0}}}$$

The methods and mechanisms described herein may be integrated within any additive manufacturing device.

The dielectric constant of a material and its refractive index are closely linked by the equation κ=n²

Referring to FIG. 6, gradient index (GRIN) optics offers degrees of freedom in the form of dimensionally varying refractive index gradients. Unlike a traditional lens, a GRIN lens affects optical paths by varying the index of refraction within the bulk of the lens. However, limited by available fabrication processes, GRIN geometries have historically been limited to simply radially symmetric index gradients.

Drop-on-demand inkjet print additive manufacturing can be used to fabricate GRIN optics. A benefit of inkjet print fabrication is the versatility it provides for depositing different material compositions throughout the volume of an optical element. As the name implies, with drop-on-demand inkjet printing, a picolitre-scale drop of optical material is precisely deposited on a substrate according to a pre-determined print pattern. By varying the properties of the feedstock, as it is printed, or by print-composing heterogeneous materials by co-depositing, mixing, and inter-diffusing multiple feedstocks as the optic is composed, layer-by-layer, it is possible to create complex volumetric index gradients within the optical element.

This concept can be applied to optics in the visible, infrared, radio-frequency portions of the electro-magnetic (EM) spectrum. By varying the properties of multiple primary optical feedstocks as they are printed, it is possible to create complex refractive index gradients within the bulk of an optical element.

In 3D GRIN materials, the refractive index may vary in up to three spatial dimensions, n(x,y,z). This allows, for example, implementation of spheric and aspheric 3D GRIN. In addition to enabling fabrication of radially symmetric spheric GRIN elements, inkjet print manufacturing is well suited for fabricating higher-order radially symmetric aspheric index gradients, as well as three-dimensional (3D) aspheric index gradients, wherein the gradient profiles may vary axially as function of their position on the optical axis. Using inkjet printing, plane parallel optical elements can be made that implement sophisticated volumetric gradient index profiles, including non-axisymmetric high-order polynomial index distributions and freeform distributions, in which the index gradients have no axis of symmetry. Inkjet print manufacturing is also particularly well suited for manufacturing freeform GRIN optical elements, in which there are no axis of symmetry in the index profiles.

These added degrees of freedom allow a single plane-parallel 3D GRIN optic to replace multiple lens surfaces, eliminating the aspects of to fabricating, aligning, and bonding multiple homogeneous index lens elements.

### Dispersion

A feature of multi-constituent nanocomposite optical inks is that it is possible to precisely tailored the refractive index spectra of the optical inks relative to one another, to control primary and secondary color. The refractive index spectral properties of the primary optical inks are a linear function of the volume fraction of the inks' constituent properties. The dispersion of homogeneous materials over the “d;F;C” spectrum is commonly characterized by the Abbe number, v, and partial dispersion, P, as

$$v = ( {n}_{d} - 1 ) / {N}_{F} - {n}_{C} )$$

$$( same as above )$$

$${P}_{d , F} = ( {n}_{F} - {n}_{d} ) / ( {n}_{F} - {n}_{C} ) .$$

For homogeneous materials with normal dispersion, v is always positive and the value of P is around 0.7 and is bounded between zero and one. The partial dispersion values of optical materials strongly trend linearly with their dispersion values.

To a good approximation, the observed refractive index n in radially symmetric optic, at any value of r, is a linear combination of n₁(λ) and n₂(λ) weighted according to the respective volume fractions of the first and second materials at that same r:

$$n ( λ , r ) = {x}_{1} ( r ) {n}_{1} ( λ ) + {x}_{2} ( r ) {n}_{2} ( λ ) .$$

For an optic including a third material, etc., the weighted sum is extended accordingly. In combination with n₁(λ) and n₂(λ), the first and second volume-fraction profiles define a gradient in the observed refractive index of the optic. The optical power derives from the controlled gradient of the observed refractive index in the radial direction, ∂n/∂r.

In other examples, the radial component may have a more complex refractive-index distribution. For some radially symmetric optics the radial component may be a superposition of radial components—e.g.,

$$n ( λ , r ) = {n}_{0} + Δ n ( {a}_{2} {r}^{2} + {a}_{4} {r}^{4} + {a}_{6} {r}^{6} + … ) ,$$

where coefficients ax weight corresponding radial powers r^{x}, and where n₀ is the refractive index at the center of the optic.

Thus, the observed refractive-index may vary in directions perpendicular and/or parallel to the optical axis. GRIN optics having refractive-index profiles of lower symmetry are also envisaged.

In contrast to optics of fixed refractive index, where all chromatic dispersion originates interfacially, a GRIN optic may exhibit chromatic dispersion originating internally. In order for a GRIN optic to provide par focus over a broad wavelength range, such dispersion must be controlled to within prescribed limits. The amount or severity of chromatic dispersion in a radially symmetric GRIN optic can be related empirically to various dispersion metrics—e.g.,

$$D \partial {n}_{Y} / \partial r = \partial {n}_{B} / \partial r - \partial {n}_{R} / \partial r$$

where n_{B} and n_{R} represent the observed refractive index for wavelengths at opposite ends of any band of interest, at any r within the optic. As a practical matter, the amount of primary dispersion may be expressed relative to ∂n_{Y}/∂r, the gradient of the observed refractive index n_{Y} in the middle of the band. Relative primary dispersion metrics, such as D, depend only on the wavelength-dependent refractive indices of the materials used, not on the distribution or magnitude of the refractive-index gradient within the optic, nor on the volume fractions of the materials therein.

If the first material of an optic has a first refractive index n₁(λ) that varies in dependence on wavelength λ, and second material has a second refractive index n₂(λ) that also varies in dependence on the wavelength. Abbreviating n₁(λ_{B}), n₁(λ_{Y}), and n₁(λ_{R}) as n₁B, n₁Y, and n₁R, respectively, and expanding in terms of the volume fractions x₁ of each material ᵢ,

$$\partial {n}_{B} / \partial r = \partial / {\partial }_{r} ( {x}_{1} ( r ) {n}_{1} B + {x}_{2} ( r ) {n}_{2} B + \text{…} ) = \partial {x}_{1} / \partial {rn}_{1} B + {\partial }_{x} 2 / \partial {rn}_{2} B + … ,$$

where x₁(r)+x₂(r)+ . . . =1, and likewise for ∂n_{Y}/∂r and ∂n_{R}/∂r. In the special case of only two materials, ∂x₂/∂r=−∂x₁/∂r. Substituting,

$$D Δ {n}_{Y} = Δ {n}_{B} - Δ {n}_{R} ,$$

where Δn_{B}=n_{1B}−n_{2B}, Δn_{B}=n_{1Y}−n_{2Y}, Δn_{B}=n_{1R}−n_{2R}, and λ_{B}<λ_{Y}<λ_{R}. Thus, in order to urge D toward zero in a GRIN optic limited to two materials, the materials must have similar n_{B}−n_{R}.

Independent control of dispersion relative to the index gradient allows for achromatic singlet GRIN lenses to be fabricated. For example, even for a binary primary optical ink pair, when the slope of the high-index optical inks, n_{F}(high)-n_{C}(high), is matched to the slope of the low-index optical ink, n_{F}(low)-n_{C}(low), such that Δn_{F}=Δn_{C}, the GRIN lens is achromatic.

In GRIN optics, the GRIN Abbe number (v_{GRIN}) and partial dispersion (P_{d,F GRIN}) are defined as

$${v}_{GRIN} = ( Δ {n}_{d} ) / Δ {n}_{F} - Δ {n}_{C} )$$

$${P}_{d , F\_GRIN} = ( Δ {n}_{F} - Δ {n}_{d} ) / ( Δ {n}_{F} - Δ {n}_{C} )$$

In our innovation we propose to represent optical index pairs as Δn described by a Sellmeir or other high order polynomial. Gradient index (GRIN) optical materials may be characterized by a Sellmeier equation. In its original and the most general form, the Sellmeier equation is given as

$${n}^{2} ( λ ) = 1 + {Σ}_{i} \frac{{B}_{i} {λ}^{2}}{{λ}^{2} - {C}_{i}}$$

where n is the refractive index, λ is the wavelength, and Bᵢ and Cᵢ are experimentally determined Sellmeier coefficients. These coefficients are usually quoted for λ in micrometers.

The gradient effects are modeled as

$$Δ {n}^{2} ( λ ) = 1 + {\sum }_{i} \frac{{B}_{i} {λ}^{2}}{{λ}^{2} - {C}_{i}}$$

Defined by the difference in the refractive index spectra of the high and low index primary optical inks use to print the gradients, the index gradients can have positive, zero, or negative v_{GRIN} values, and when more than three constituents are used to synthesize the feedstock, the dispersion can be defined independently from the index gradient.

Moreover, by introducing sufficient additional constituents into the feedstock composition, it is possible to relax the dependence of the P_{GRIN} values relative to the V_{GRIN} values; thus, making possible a wide range of anomalous partial dispersion GRIN materials not available in standard glass or plastic materials. Achieving dispersion and partial-dispersion values independent of the index gradient is of critical important for freeform refractive optical elements, due to the complexity of dispersion attributable to freeform surfaces and gradient index functions.

The introduction of increased numbers of inks with different material compositions adds dimensions to the design space for use in optimizing the chromatic properties of optics. In a binary blend of two materials, the refractive index and the change in index over wavelength (i.e., the dispersion) are dependent, so specifying one determines the other. The ability to print-compose gradients by co-depositing and mixing multiple optical inks, with specific refractive index spectra, provides the ability to break this dependency, so that index and dispersion may be controlled independently.

Additionally, the optical inks, themselves, may be formulated by blending multiple constituent materials. Using different concentrations of an ensemble of monomers, nanoparticles, ligands, and surfactants, each contributing, on a weighted average, its own refractive index spectrum, makes it possible to precisely tailor the refractive index spectra, n_{λ}, of primary optical inks relative to one another.

Print composing multiple heterogeneous primary optical inks with complementary refractive index spectra, provides significant degrees of freedom for optimizing the chromatic properties of GRIN optic designs. For example, the refractive index spectra of primary optical inks may be composed such that the print-composed index gradient and dispersion are independent of one another. Print composition of multiple heterogenous primary optical inks also makes it possible to design optical materials with a large variety of anomalous partial dispersion values that are not available in standard glass or plastic materials.

In this context, the formulations of nanocomposite materials for GRIN optics creates a multi-dimensional design space. A simple three-dimensional design space may include the orthogonal dimensions of refractive index, dispersion, and partial dispersion. In this case, the specific properties of miscible high-index and low-index primary optical inks are reflected on the refractive index axis as well as on the dispersion and partial dispersion axis dimensions. The volume of the design space is then bounded by the three-dimensional coordinates of the primary inks.

Within the bounds imposed by the properties of the primary optical inks, print composition of different concentration ratios of two, or more, high and low index primary ink droplets creates intermediate index gradients, which define application-specific lines, curves, planes, or contoured surface solutions within the three-dimensional design space. These solutions may include solutions for compensating the dispersion from curved surface figures.

When dispersion is created at the surface of the optic, either through surface shapes or from non-paraxial ray, it may be compensated within the volume of the GRIN optic volume. For example, for a simple curved surface, if a neutral optical element is desired, there is an equivalent GRIN profile that has an opposite and equal optical power. If dispersion and partial-dispersion are to be corrected, for a given device thickness, there is a gradient profile that corrects for the surface induced dispersion and partial dispersion.

### Achromatic GRIN Singlet

The optical power φ_{R}(λ) of a thin refractive lens fabricated from a material with refractive index n(λ) and curvatures R_{f} and R_{b} on its front and back surfaces is

$${ϕ}_{R} ( λ ) = ( \frac{1}{{R}_{f}} - \frac{1}{{R}_{b}} ) [ n ( λ ) - 1 ]$$

where λ represents wavelength. By definition, the change in optical power as a function of wavelength is

$$\frac{d {ϕ}_{R} ( λ )}{d λ} = \frac{{ϕ}_{G} ( λ )}{{V}_{G} ( λ )}$$

where V(λ) is a generalization of the Abbe representation of dispersion

$$V ( λ ) = \frac{ϕ ( λ )}{{ϕ}^{′} ( λ )}$$

Using dot-notation, e.g., φ′(λ), to indicate differentiation with respect to wavelength λ.,

$${V}_{R} ( λ ) = \frac{n ( λ ) - 1}{{n}^{′} ( λ )}$$

Although the quantity \dot{n}′(λ) is related to dispersion, i.e., index as a function of wavelength, to ensure clarity in this work, it is referred to as the index slope.

### GRIN Lens

The optical power for a pair of lenses with individual powers φ₁(λ) and φ₂(λ) is

$$ϕ ( λ ) = {ϕ}_{1} ( λ ) + {ϕ}_{2} ( λ )$$

and the continuous change in optical power for this doublet is

$${ϕ}^{′} ( λ ) = {ϕ}_{1}^{′} ( λ ) + {ϕ}_{2}^{′} ( λ ) = \frac{{ϕ}_{1} ( λ )}{{V}_{1} ( λ )} + \frac{{ϕ}_{2} ( λ )}{{V}_{2} ( λ )}$$

An ideal achromat satisfies φ′₁(λ)=−φ′₂(λ) for all λ.

If this is true, the optical power is constant for all wavelengths. Holding the paraxial power sum constant with wavelength is not the same as holding the back focal length constant, which forces each color to focus on a common image plane. The approach allows isolation of chromatic properties of the material pair from geometrical factors of the lenses.

The approach herein to generalize achromatic doublet design separates materials-based, wavelength-dependent functions h(λ) from constant C geometric-based terms. This allows representation of the power of a doublet as

$$ϕ ( λ ) = {C}_{1} {h}_{1} ( λ ) + {C}_{2} {h}_{2} ( λ )$$

As formulated here, the h functions are unitless quantities, while the constants C have units of optical power. To correct first-order chromatic aberrations, we constrain the doublet so that it is achromatic only at the design wavelength λ₀,

$${C}_{1} {h}_{1} ( λ ) = - {C}_{2} {h}_{2} ( λ )$$

The geometric factors are, therefore,

$${C}_{1} = \frac{{h}_{2}^{′} ( {λ}_{0} ) ϕ ( {λ}_{0} )}{{h}_{1} ( {λ}_{0} ) {h}_{2}^{′} ( {λ}_{0} ) - {h}_{2} ( {λ}_{0} ) {h}_{1}^{′} ( {λ}_{0} )}$$

$${C}_{2} = \frac{{h}_{1}^{′} ( {λ}_{0} ) ϕ ( {λ}_{0} )}{{h}_{1} ( {λ}_{0} ) {h}_{2}^{′} ( {λ}_{0} ) - {h}_{2} ( {λ}_{0} ) {h}_{1}^{′} ( {λ}_{0} )}$$

One can now express the ratio of φ(λ) to φ(λ₀) as a function only of the material, wavelength-dependent functions:

$$\frac{ϕ ( λ )}{ϕ ( {λ}_{0} )} = \frac{{h}_{1} ( λ ) {h}_{2}^{′} ( {λ}_{0} ) - {h}_{2} ( λ ) {h}_{1}^{′} ( {λ}_{0} )}{{h}_{1} ( {λ}_{0} ) {h}_{2}^{′} ( {λ}_{0} ) - {h}_{2} ( {λ}_{0} ) {h}_{1}^{′} ( {λ}_{0} )}$$

By examining only the dispersion of each material, one can deduce the relative wavelength dependence of a doublet, regardless of that doublet's geometry or power. This allows examination of the chromatic compatibility of different materials for a given doublet type. This is a necessary, but not sufficient, condition for determining a good material pair.

Consider two materials whose material properties are related via

$${h}_{1} ( λ ) = {h}_{2} ( λ ) + Δ n$$

A doublet from such materials can be made perfectly achromatic if C2=−C1. Given these conditions, the lens power is

$$ϕ ( λ ) = {C}_{1} Δ n$$

Note that, for a fixed optical power, the index difference Δn and element geometry (e.g., thickness or surface curvature as represented by C1) are inversely proportional. In other words, if Δn is small, a reasonable doublet power requires C1 (and, by extension, C2=−C1) to be large. Thus, despite the apparent attractiveness of the chromatic properties of the material pair, the lens thickness or surface curvatures may be extreme for a reasonable lens. Indeed, in the limit as Δn approaches 0, this is like trying to make a doublet using two elements cut from the same glass.

A GRIN lens geometry is depicted in FIG. 7. A plano-convex lens is shaped in such a way that the center of GRIN curvature lies on the optical axis but well outside the lens, either in front of or behind it. To determine the focusing properties of the lens, one may compute the wavefront transmitted through the optic when illuminated by plane parallel light. In accordance with the thin lens approximation, the phase-front is calculated as if light remains parallel to the propagation axis throughout the lens element. Because of the lens and GRIN symmetry the wavefront is cylindrically symmetric, so it is sufficient to compute the wavefront φ(y) along one axis y perpendicular to the propagation direction z:

$$ϑ ( y ) = {k}_{0} Δ z ( y ) + {k}_{0} {\int }_{Δ z ( y )}^{k} n [ r ( y , z ) ] d z$$

where k₀ is the vacuum wavevector of the light, Δz(y) is the distance in air from the vertex plane to the lens surface at height, y, t_{c} is the center thickness of the lens, r(y,z) is proportional to the distance from the GRIN center of curvature at point (y,z) within the lens, and n(r) is the index of refraction at r. The first term is the accumulated phase in air before striking the curved front surface, while the second represents the phase from traversing the GRIN.

The function r(y,z) is found from:

$$r ( y , z ) = \frac{{R}_{G}}{\vert {R}_{G} \vert} \sqrt{( {y}^{2} + {( {R}_{G} - z )}^{2}}$$

where R_{G} is the radius of curvature of the GRIN contour at the lens vertex, with the usual sign convention R_{G}>0 if the center lies to the right of the lens and R_{G}<0 otherwise. Note that for R_{G}<0, r takes on negative values within the lens. As mentioned above, a simple linear relationship for the index of refraction is used:

$$n ( r ) = a ( r - {R}_{G} )$$

where n₀ is the index of refraction of the lens at its vertex and a is the rate of index change with distance. For all values of R_{G} the index of refraction n₁ at the back vertex of the lenses is given by n₁=n₀−a t_{c}.

An analytic approximation for the focal length f(λ) of the plano-convex GRIN lens:

$$f ( λ ) = {( \frac{{n}_{0} ( λ ) - 1}{{R}_{L}} - \frac{a ( λ ) {t}_{c}}{{R}_{G}} )}^{- 1}$$

The first term is simply what the lens maker's equation predicts for a plano-convex lens. The two-term is analogous to the thin-lens focal length expression for a compound lens, f=(1/f₁+1/f₂)⁻¹

The paraxial power of a radial GRIN lens with refractive indices n_{ctr}(λ) and n_{edg}(λ) at its center and edge, respectively, diameter D, thickness t, and curvatures R_{f} and R_{b} on its front and back surfaces is

$${ϕ}_{G} ( λ ) = {ϕ}_{R} ( λ ) C [ ϕ ( λ ) ] + [ {ϕ}_{W} ( λ ) + {ϕ}_{R 2} ( λ ) S n c [ ϕ ( λ ) ]$$

The functions C[φ(λ)] and Snc [φ(λ)] are defined, by C[φ(λ)]=cos hφ(λ) and S[φ(λ)]=sin hφ(λ) for negative gradients and C[φ(λ)]=cos φ(λ) and S[φ(λ)]=sin φ(λ) for positive gradients.

φ_{R} is the contribution from a homogeneous refractive lens, φ_{g} is the contribution form the GRIN.

The optical power of a Wood lens is

$$ϕ ( λ ) = \frac{8 t}{{D}^{2}} {n}_{center} ( λ ) - \frac{8 t}{{D}^{2}} {n}_{edge} ( λ )$$

In the generalized achromat form,

$${C}_{1} = \frac{8 t}{{D}^{2}}$$

$${C}_{2} = \frac{8 t}{{D}^{2}}$$

$${h}_{1} ( λ ) = {n}_{center} ( λ ) ; {h}_{2} ( λ ) = {n}_{edge} ( λ )$$

A Wood lens is achromatic if there exist materials that satisfy

$${n}_{center} ( λ ) = {n}_{center} ( λ ) + Δ n$$

Under these conditions, the lens power is

$$ϕ ( λ ) = \frac{8 t}{{D}^{2}} Δ n$$

If the optical power and lens diameter are fixed, the index difference and lens thickness are inversely proportional. The larger the Δn, the thinner the lens to achieve a given power. Conversely, if Δn is small, the lens must be thick to achieve reasonable power.

### Curved GRIN Achromats

The paraxial power of a curved, radial GRIN singlet is given by

$$ϕ ( λ ) = ( \frac{1}{{R}_{f}} - \frac{1}{{R}_{b}} ) [ ( {n}_{center} ( λ ) - 1 ) ] + ( \frac{8 t}{{D}^{2}} ) [ ( {n}_{center} ( λ ) - 1 ) ]$$

Rearranging terms allows identification of the dispersive and geometric factors,

$${C}_{1} = \frac{1}{{R}_{f}} - ( \frac{1}{{R}_{b}} - \frac{8 t}{{D}^{2}} )$$

$${C}_{2} = ( \frac{1}{{R}_{b}} - \frac{8 t}{{D}^{2}} ) - ( \frac{1}{{R}_{b}} )$$

$${h}_{1} ( λ ) = {h}_{center} ( λ ) - 1$$

$${h}_{2} ( λ ) = {h}_{edge} ( λ ) - 1$$

For a Wood lens (cylindrical GRIN lens) to have the same focal length for all wavelengths, the first derivatives of the dispersion curves for the center and edge materials must be equal to one another. In other words, their dispersion curves differ only by a constant index contrast Δn, whereby C[φ(λ)]≈S[φ(λ)]/φ(λ)≈1.) We note that C(0)=Snc(0)=1.

The function φ(λ) is the gradient strength,

$$Φ ( λ ) = \sqrt{\frac{8 {t}^{2}}{{D}^{2}} \frac{[ {n}_{edge} ( λ ) - {n}_{center} ( λ ) ]}{{n}_{center} ( λ )}}$$

The index profile n(r, λ) that generates this power is

$$n ( r , λ ) = {n}_{center} ( λ ) + {[ {n}_{edge} ( λ ) - {n}_{center} ( λ ) ] [ \frac{r}{D} ]}^{2}$$

A good approximation to φ_{G}(λ) keeps just the refractive and Wood lens terms,

$${ϕ}_{G} ( λ ) = {ϕ}_{R} ( λ ) + {ϕ}_{W} ( λ )$$

$${ϕ}_{G}^{′} ( λ ) = \frac{{ϕ}_{R} ( λ )}{{V}_{R} ( λ )} + \frac{{ϕ}_{W} ( λ )}{{V}_{W} ( λ )}$$

where the individual powers are

$${ϕ}_{R} ( λ ) = ( \frac{1}{{R}_{f}} - \frac{1}{{R}_{b}} ) [ {n}_{center} ( λ ) - 1 ]$$

$${ϕ}_{W} ( λ ) = ( \frac{8 t}{{D}^{2}} ) [ {n}_{center} ( λ ) - {n}_{edge} ( λ ) ]$$

The dispersion of a Wood lens V_{W}(λ) is given by

$${V}_{W} ( λ ) = \frac{{n}_{center} ( λ ) - {n}_{edge} ( λ )}{{n}_{center}^{′} ( λ ) - {n}_{edge}^{′} ( λ )}$$

Note that a Wood lens, wherein the change in refractive index from center to edge is small, relative to the change in index slopes, is highly dispersive. A lens with a small change in index slopes is almost nondispersive. One interpretation is that a GRIN lens can be modeled as a doublet consisting of a refractive lens and a Wood lens

$${ϕ}_{G} ( λ ) = {ϕ}_{c e n t e r} ( λ ) + {ϕ}_{e d g e} ( λ )$$

$$where$$

$${ϕ}_{center} ( λ ) = [ \frac{1}{{R}_{f}} - ( \frac{1}{{R}_{b}} - \frac{8 t}{{D}^{2}} ) ] [ {n}_{center} ( λ ) - 1 ]$$

$${ϕ}_{edge} ( λ ) = [ ( \frac{1}{{R}_{b}} - \frac{8 t}{{D}^{2}} ) ( \frac{1}{{R}_{b}} ) ] [ {n}_{edge} ( λ ) - 1 ]$$

These equations represent a standard, homogeneous doublet comprised of pure materials of n_{ctr}(λ) followed by n_{edg}(λ). The doublet has the same outer surface curvatures of the GRIN lens with a common interface like a cemented doublet.

This equivalence indicates that, for thin lenses which satisfy the paraxial approximation, a radial GRIN singlet performs like a homogeneous doublet. However, This equivalence is negated for thick lenses. When lens thickness is unconstrained, there exist material pairs that perform well as GRIN achromats, but poorly as homogeneous doublets

### Achromat Design

Due to the number of parameters involved, one may choose lens parameters which allow for identical focal lengths at two different wavelengths. To see how the parameters are chosen, one may consider the difference in optical powers 1/f for the same lens at two different wavelengths λ_{blue} and λ_{red}:

$$\frac{1}{{f}_{blue}} - \frac{1}{{f}_{red}} = \frac{( {n}_{0} ( {λ}_{blue} ) - {n}_{0} ( {λ}_{red} ) )}{{R}_{L}} - \frac{( {n}_{0} ( {λ}_{blue} ) - {n}_{0} ( {λ}_{red} ) ) - ( {n}_{1} ( {λ}_{blue} ) - {n}_{1} ( {λ}_{red} ) )}{{R}_{G}}$$

It is important to recall that (a t_{c}) is equal to the difference in index between the front and back vertices (n₀-n₁).

If only materials with normal dispersion are considered, and one assumes a plano-convex lens, then the first term may always be positive. To obtain a chromatically balanced lens, therefore, the second term must also be positive, and equal to the first term.

$$\frac{( {n}_{0} ( {λ}_{blue} ) - {n}_{0} ( {λ}_{red} ) )}{{R}_{L}} = \frac{( {n}_{0} ( {λ}_{blue} ) - {n}_{0} ( {λ}_{red} ) ) - ( {n}_{1} ( {λ}_{blue} ) - {n}_{1} ( {λ}_{red} ) )}{{R}_{G}}$$

To obtain an idea of the lens geometries required for a balanced lens, assume that the material at the front vertex has a higher index, and correspondingly higher dispersion, than the material at the back vertex. In this case the dispersion at the front vertex (n_{0blue}-n_{0red}) would be greater than that at the back vertex (n_{1blue}-n_{1red}) and the GRIN radius of curvature R_{G} would have to be greater than zero to get a balanced lens. Taking the same materials but reversing their order, so that the high-index material is located at the back vertex, requires the sign of R_{G} to change in order to maintain a chromatic balance.

In designing these lenses, one may consider the GRIN radius R_{G} and material properties fixed and solve for the radius of curvature R_{L} which sets the focal length difference (above) equal to zero:

$${R}_{L} = {R}_{G} \frac{Δ {n}_{0}}{Δ {n}_{0} - Δ {n}_{1}}$$

One may adopt the shorthand δnⱼ=[nⱼ(λ_{blue})−nⱼ(λ_{red})] at surface j. One may express the balanced focal length, where f_{red}=f_{blue}, by

$${f}_{balanced} = \frac{{R}_{G} / δ {n}_{1}}{\frac{{n}_{1} ( {λ}_{red} ) - 1}{δ {n}_{1}} - \frac{{n}_{0} ( {λ}_{red} ) - 1}{δ {n}_{0}}}$$

In view of the preceding description, the present disclosure relates to a kind of multiple layer optical device which includes a graded index (GRIN) lens. According to one embodiment, a GRIN optical device is fabricated onto an optic or optical assembly, whereby the gradient index functions are designed to complement the optical functions of the underlying optical device. The GRIN layer can be used to augment the optical power of the device, correct for geometric aberrations, or correct for chromatic aberrations, resulting from, or in combination, with the optical functions of the first (homogeneous) optical elements.

The present disclosure discloses the following examples.

Example 1. A hybrid optical device comprising: a first component including a homogeneous region of dielectric property; and a second component including a heterogeneous region of dielectric property.

Example 2. The hybrid optical device of example 1, wherein the heterogeneous region of dielectric property is a gradient refractive index device.

Example 3. The hybrid optical device of example 1, wherein the heterogeneous region of dielectric property is a gradient refractive index device with index variation in three-dimensions, including: both axial and radial components, freeform in x-y (or planar r, θ) coordinates, and freeform in x-y-z (or spherical r, θ) coordinates.

Example 4. The hybrid optical device of any of examples 1-3, wherein the heterogeneous region of dielectric property is a gradient refractive index device comprised of an optical feedstock containing at least three constituents.

Example 5. The hybrid optical device of any of examples 1-4, wherein the heterogeneous region of dielectric property has a gradient structure configured to reduce or eliminate aberrations induced by the homogeneous region of dielectric property.

Example 6. The hybrid optical device of any of examples 1-5, wherein the heterogeneous region of dielectric property has a gradient structure configured to compensate or augment an optical power of the first component that includes the homogeneous region of dielectric property.

Example 7. The hybrid optical device of any of examples 1-6, wherein the heterogeneous region of dielectric property has a gradient structure configured to reduce or eliminate aberrations induced by the homogeneous region of dielectric property; wherein a slope of the gradient structure is proportional to at least one portion of a surface curve of the device; wherein a dispersion of the gradient structure is proportional to at least a portion of the curve of the surface of the device; wherein a secondary color of the gradient structure is proportional to at least a portion of the curve of the surface of the device.

Example 8. The hybrid optical device of any of examples 1-7, further comprising: an index matching layer deposited on or at a surface between the homogeneous region and the heterogeneous region.

Example 9. The hybrid optical device of any of examples 1-8, wherein the heterogenous region is deposited as an index layer between two homogeneous layers of the homogeneous region.

Example 10. The hybrid optical device of any of examples 1-8, wherein the heterogeneous region includes two heterogenous index layers deposited about a homogeneous layer of the homogeneous region.

Example 11. The hybrid optical device of any of examples 1-10, wherein the heterogenous region is printed on a flat portion of a lens (e.g., a homogeneous lens formed by the homogeneous region).

Example 12. The hybrid optical device of any of examples 1-10, wherein the heterogenous region is printed on a curve portion of a lens (e.g., a homogeneous lens formed by the homogeneous region).

Example 13. The hybrid optical device of any of examples 1-12, wherein the heterogenous region is formed, molded, or machined to have surface curvature.

Example 14. The hybrid optical device of any of examples 1-13, wherein a waveguide is included in the heterogenous region; and wherein a grating is included in the heterogenous region.

Example 15. The hybrid optical device of any of examples 1-14, wherein the heterogeneous region of dielectric property is fabricated using inkjet print fabrication; wherein the heterogeneous region is deposited directly onto the homogeneous region during fabrication; wherein the hybrid optical device is concave-plano or convex-plano and the heterogeneous region is printed on a plano side, or wherein the hybrid optical device is concave-plano or convex-plano and the heterogeneous region is printed on a curved side, or wherein the hybrid optical device has bi-convex or bi-concave and the heterogeneous region is printed on either side.

Example 16. The hybrid optical device of any of examples 1-15, wherein a wetting layer is deposited on a surface between the homogeneous region and the heterogeneous region to promote adhesion of inkjet deposited materials.

Example 17. The hybrid optical device of any of examples 1-16, wherein the homogeneous region is mounted to a fixture to allow for the heterogenous region to be formed.

Example 18. The hybrid optical device of any of examples 1-17, wherein the homogeneous region includes a waveguide.

Example 19. The hybrid optical device of any of examples 1-18, wherein the homogeneous region includes a grating.

Example 20. The hybrid optical device of any of examples 1-19, wherein the heterogenous region has Fresnel optical features.

Example 21. The hybrid optical device of any of examples 1-20, wherein optical functions of the homogenous region and the heterogenous region form part of a virtual reality device or an augmented reality device.

Example 22. The hybrid optical device of any of examples 1-20, wherein optical functions of the homogenous region and the heterogenous region form part of a vision accommodation device.

Example 23. The hybrid optical device of any of examples 1-22, wherein an anti-reflective coating is deposited into the heterogenous region or onto a surface of the heterogeneous region; and/or wherein the hybrid optical device further comprises the anti-reflective coating within the heterogenous region or on a surface of the heterogeneous region.

Example 24. The hybrid optical device of any of examples 1-23, wherein a GRIN function is constructed relative to a position or optical functions of a human eye.

Example 25. The hybrid optical device of any of examples 1-24, wherein a range of indices of a GRIN function overlaps an index of homogeneous materials of the homogeneous region.

Example 26. The hybrid optical device of any of examples 1-25, wherein the hybrid optical device is optimized for infrared spectral range.

Example 27. The hybrid optical device of any of examples 1-25, wherein the hybrid optical device is optimized for RF spectral range.

Example 28. The hybrid optical device of any of examples 1-27, wherein the hybrid optical device is formed by manipulating permittivity or permeability.

It will be understood that the configurations and/or approaches described herein are exemplary in nature, and that these specific embodiments or examples are not to be considered in a limiting sense, because numerous variations are possible. The subject matter of the present disclosure includes all novel and non-obvious combinations and sub-combinations of the various processes, configurations, and other features, functions, acts, and/or properties disclosed herein, as well as any and all equivalents thereof.

1. A hybrid optical device comprising:
a first component including a homogeneous region of dielectric property; and
a second component including a heterogeneous region of dielectric property.

2-28. (canceled)
